(19) United States
(12) Patent Application Publication
(10) Pub. No.: US 2025/0007152 A1
(43) Pub. Date: Jan. 2, 2025

(54) A METHOD FOR ADJUSTING A TILT ANGLE OF AN ANTENNA OF A BASE STATION

(71) Applicant: Elisa Oyj, Helsinki (FI)

(72) Inventor: Veijo HÖYKINPURO, Helsinki (FI)

(73) Assignee: Elisa Oyj, Helsinki (FI)

(21) Appl. No.: 18/273,842

(22) PCT Filed: Jan. 17, 2022
(86) PCT No.: PCT/FI2022/050027

§ 371 Date: Jul. 24, 2023

(30) Foreign Application Priority Data
Jan. 28, 2021 (FI) 20215091

(51) Int. Cl. H01Q 3/06; H01Q 1/12; H04W 64/00

(52) U.S. Cl. CPC H01Q 3/06; H01Q 1/125; H04W 64/003

(57) ABSTRACT

A computer implemented method for adjusting a tilt angle of an antenna of a base station of a communications network is provided. The method includes at least: obtaining data related to the base station having user equipment distance data and antenna data; calculating a main radiation beam reach for a first antenna from the antenna data; calculating a characteristic user equipment distance from the user equipment distance data; comparing the calculated main radiation beam reach and the calculated characteristic user equipment distance; and responsive to detecting that the characteristic user equipment distance is greater than the main radiation beam reach, calculating a new antenna tilt angle for the first antenna.

### TECHNICAL FIELD

The present disclosure generally relates to adjusting an antenna of a base station of a communications network.

### BACKGROUND

This section illustrates useful background information without admission of any technique described herein representative of the state of the art.

Optimizing antenna tilt angles is important to ensure maximum capacity of communications networks, especially in 4G and 5G networks where large amounts of data is being transferred. The optimization of antenna tilt angles often focuses on minimizing the interference caused by the serving cells to other cells by downtilting the antennas. The power from the antenna may then be directed too close to the antenna and most of the traffic may come from outside the main beam or main lobe of the antenna.

The solutions of the present disclosure is are directed to solving, or at least to mitigating, the problem described above.

### SUMMARY

The appended claims define the scope of protection. Any examples and technical descriptions of apparatuses, products and/or methods in the description and/or drawings not covered by the claims are presented not as embodiments but as background art or examples useful for understanding the solutions of the present disclosure.

According to a first example aspect there is provided a computer implemented method for adjusting a tilt angle of an antenna of a base station of a communications network. The method comprises:
obtaining data related to the base station comprising user equipment distance data and antenna data;
calculating a main radiation beam reach for a first antenna from the antenna data;
calculating a characteristic user equipment distance from the user equipment distance data;
comparing the calculated main radiation beam reach and the calculated characteristic user equipment distance; and
responsive to detecting that the characteristic user equipment distance is greater than the main radiation beam reach, calculating a new antenna tilt angle for the first antenna.

In an embodiment, the antenna data comprises antenna radiation pattern data, antenna height data, and antenna tilt angle data.

In an embodiment, characteristic user equipment distance is a distance comprising a predefined percentage of user equipment in one or more cells that use the first antenna.

In an embodiment, the main radiation beam reach of the first antenna is calculated as a distance from the base station, where the radiation power of the main radiation beam of the first antenna decreases to a pre-set portion of the maximum radiation power of the main radiation beam.

In an embodiment, the pre-set portion of the maximum radiation power of the main radiation beam is a half of the maximum radiation power or a 3 dB attenuated power of the maximum power.

In an embodiment, the characteristic user equipment distance is calculated as a distance comprising a pre-defined percentage of the user equipment, preferably 40% or 50% or 60% or 70% or 40-70% of the user equipment.

In an embodiment, the user equipment distance data comprises timing advance (TA) data.

In an embodiment, the new antenna tilt angle is calculated by uptilting the antenna tilt angle by a fixed angle, preferably by one degree.

In an embodiment, the main radiation beam reach is limited by a maximum allowed reach.

In an embodiment, the maximum allowed reach extends at most to 7th or 8th or 9th or 10th decile of the user equipment distances.

In an embodiment, the maximum allowed reach extends at most to a distance comprising 70-100% of the user equipment, or 70% or 80% or 90% or 100% of the user equipment.

In an embodiment, the maximum allowed reach is at most 0.6-1.0 times the distance from the base station to a nearest neighbour.

In an embodiment, the maximum allowed reach is at most 0.8 times the distance from the base station to the nearest neighbour.

In an embodiment, the new antenna tilt angle is iterated once or twice or thrice.

In an embodiment, the new antenna tilt angle is further uptilted until the main radiation beam reach is greater than the characteristic user equipment distance and/or the maximum allowed reach is reached and/or a pre-set antenna tilt angle limit is reached.

In an embodiment, altitude of the ground is accounted for in calculating the main radiation beam reach.

In an embodiment, the new antenna tilt angle is deployed to the first antenna.

According to a second example aspect of the present disclosure, there is provided an apparatus comprising a processor and a memory including computer program code; the memory and the computer program code configured to, with the processor, cause the apparatus to perform the method of the first aspect or any related embodiment.

According to a third example aspect there is provided a computer program comprising computer executable program code which when executed by at least one processor causes an apparatus at least to perform the method of the first aspect or any related embodiment.

According to a fourth example aspect there is provided a computer program product comprising a non-transitory computer readable medium having the computer program of the third example aspect stored thereon.

According to a fifth example aspect there is provided an apparatus comprising means for performing the method of any preceding aspect.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of an electronic device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows a system according to an example embodiment;

FIG. 2 shows a block diagram of an apparatus according to an example embodiment;

FIG. 3 shows a flow chart according to an example embodiment; and

FIGS. 4A and 4B show example embodiments related to non-flat terrain.

### DETAILED DESCRIPTION

In the following description, like reference signs denote like elements or steps.

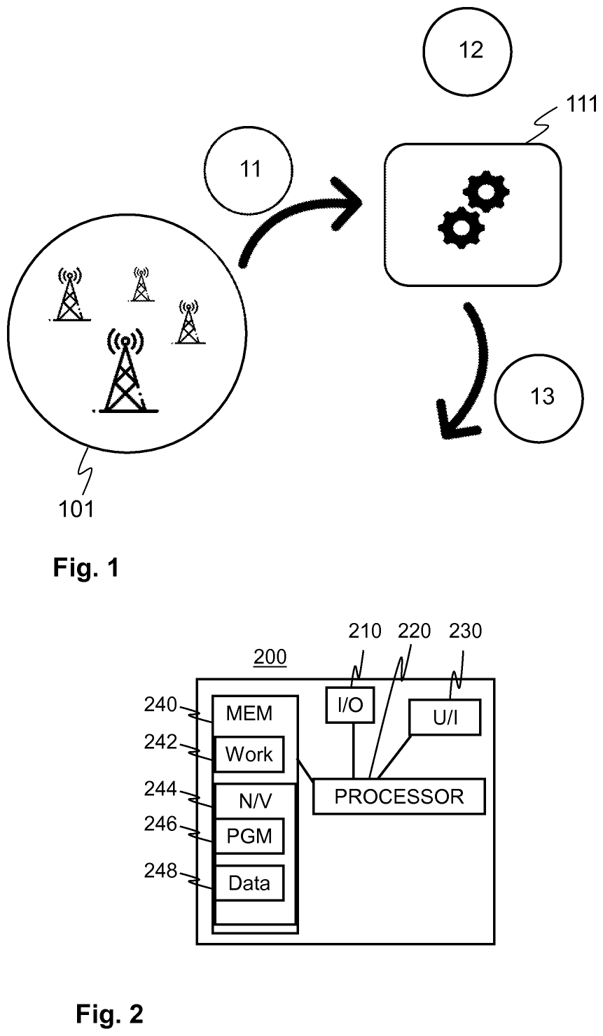

FIG. 1 shows an example scenario according to an embodiment. The scenario shows a communication network 101 comprising a plurality of cells and base station sites and other network devices, and an automated system 111 configured to control an antenna of a cell of a communication network.

In an embodiment of the present disclosure the scenario of FIG. 1 operates as follows: In phase 11, the automated system 111 receives data related to the base stations. The data comprises user equipment distance data and antenna data.

In phase 12, the automated system 111 uses the received data to analyze the operation of an antenna of the base station and calculates a new adjusted tilt angle for the antenna or antennas. Operation of multiple antennas of the base station or multiple antennas of multiple base stations may also be analyzed. In some embodiments, terrain height in the surroundings of the base station is accounted for by obtaining and using an additional data comprising topographical data, map data, geographical data, and/or terrain height data.

In phase 13, the calculated new tilt angle or angles may be outputted and deployed to the antenna or antennas.

The process may be manually or automatically triggered. The process may be periodically repeated. The process may be repeated for example once a day, once a week, every two weeks, or once a month. By periodically repeating the process, effective network monitoring and controlling is achieved and problems, if any, may be timely detected. Additionally or alternatively, the process may be triggered, for example, in response to observing problems or anomalies in the network. Still further, the process may be performed in connection with deployment of new cells or base station site, deployment of new physical equipment in the base station site and/or maintenance actions performed in the base station site.

FIG. 2 shows a block diagram of an apparatus 200 according to an example embodiment. The apparatus 200 comprises a communication interface 210; a processor 220; a user interface 230; and a memory 240. The apparatus 200 can be used for implementing at least some embodiments of the present disclosure. That is, with suitable configuration the apparatus 200 is suited for operating for example as the automated system 111.

The communication interface 210 comprises in an embodiment a wired and/or wireless communication circuitry, such as Ethernet; Wireless LAN; Bluetooth; GSM; CDMA; WCDMA; LTE; and/or 5G circuitry. The communication interface can be integrated in the apparatus 200 or provided as a part of an adapter, card or the like, that is attachable to the apparatus 200. The communication interface 210 may support one or more different communication technologies. The apparatus 200 may also or alternatively comprise more than one of the communication interfaces 210.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the apparatus 200, e.g., via a keyboard; graphical user interface shown on the display of the apparatus 200; speech recognition circuitry; or an accessory device; such as a headset; and for providing output to the user via, e.g., a graphical user interface or a loudspeaker.

The memory 240 comprises a work memory 242 and a persistent memory 244 configured to store computer program code 246 and data 248. The memory 240 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The apparatus 200 may comprise a plurality of the memories 240. The memory 240 may be constructed as a part of the apparatus 200 or as an attachment to be inserted into a slot; port; or the like of the apparatus 200 by a user or by another person or by a robot. The memory 240 may serve the sole purpose of storing data, or be constructed as a part of an apparatus 200 serving other purposes, such as processing data.

A skilled person appreciates that in addition to the elements shown in FIG. 2, the apparatus 200 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the apparatus 200 may comprise a disposable or rechargeable battery (not shown) for powering the apparatus 200 if external power supply is not available.

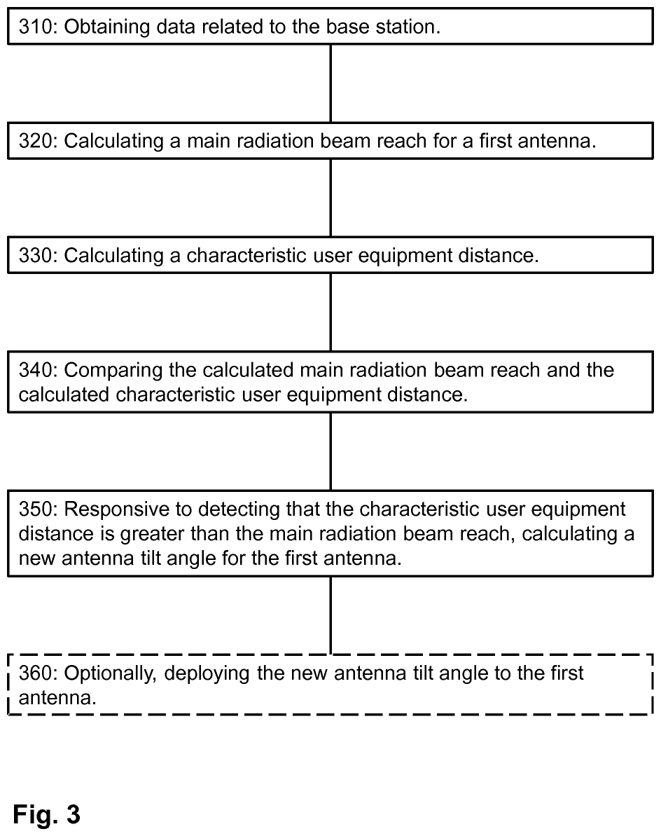

FIG. 3 shows a flow chart according to an example embodiment. FIG. 3 illustrates a computer implemented method for adjusting a tilt angle of an antenna of a base station of a communications network comprising various possible process steps including some optional steps while also further steps can be included and/or some of the steps can be performed more than once:

310: Obtaining data related to the base station. The data related to the base station may comprise user equipment distance data. The user equipment data may comprise data from a single cell. The user equipment data may comprise data from multiple cells using a same antenna. The data related to the base station may comprise antenna data. The antenna data may comprise antenna height data. The antenna data may comprise antenna tilt angle data. The antenna data may comprise antenna radiation pattern data. Furthermore, other antenna related data may be comprised in the antenna data. In some embodiments, the data related to the base station comprises user equipment distance data, antenna height data, antenna tilt angle data, and antenna radiation pattern data. In some embodiments, the antenna tilt angle data, the antenna height data, and the antenna radiation pattern data comprise data related to a first antenna. In some embodiments, the antenna tilt angle data, the antenna height data, and the antenna radiation pattern data comprise data related to more than one antenna. Further data related to the base station, to the network, or to the user equipment may also be obtained. In some embodiments, topographical data, map data, geographical data, and/or terrain height data may be obtained.

The data related to the base station may be obtained for example form the base station, from network planning systems and/or other sources.

320: Calculating a main radiation beam reach for a first antenna. The main radiation beam, or main radiation lobe, reach may be calculated using the antenna radiation pattern data, the antenna height data, and the antenna tilt angle data. In an embodiment, the main radiation beam reach of the first antenna may be calculated as a farthest distance from the base station, where the radiation power of the main radiation beam of the first antenna is still above a pre-set threshold value. The main radiation beam reach of the first antenna may be calculated as a distance from the base station, where the radiation power of the main radiation beam of the first antenna decreases to half of the maximum radiation power of the main radiation beam. The main radiation beam reach of the first antenna may be calculated as a distance from the base station, where the radiation power of the main radiation beam of the first antenna has attenuated 3 dB from the maximum value.

In a further embodiment, altitude of the ground is accounted for in calculating the main radiation beam reach. Altitude of the ground may be accounted for by adjusting a relative height of an antenna by increasing the relative height if terrain height is decreasing, and/or decreasing the relative height if terrain height is increasing.

330: Calculating a characteristic user equipment distance. The distance is distance from the first antenna. The characteristic user equipment distance may be calculated from the user equipment distance data. In an embodiment, the characteristic user equipment distance is calculated as a distance comprising a pre-defined percentage of the user equipment. The characteristic user equipment distance may be a distance that covers a predefined percentage of user equipment in one or more cells that use the first antenna. In an embodiment, the user equipment distance data comprises timing advance (TA) data. The pre-defined percentage of the user equipment may be 40-70%. The pre-defined percentage of the user equipment may be 40% or 50% or 60% or 70%. In an embodiment, the characteristic user equipment distance is calculated as a distance including 5 or 6 or 7 or 8 or 9 smallest deciles of the user equipment distances.

340: Comparing the calculated main radiation beam reach and the calculated characteristic user equipment distance.

By calculating the characteristic user equipment distance based on the predefined percentage of the user equipment and comparing this to the main radiation beam reach one achieves ability to identify situations, where large part of the users of the cell are located outside the main radiation beam.

350: Responsive to detecting that the characteristic user equipment distance is greater than the main radiation beam reach, calculating a new antenna tilt angle for the first antenna. The new antenna tilt angle preferably results in uptilting the antenna. Uptilting antenna effectively increases main radiation beam reach. In an embodiment, the new antenna tilt angle is calculated by uptilting the antenna tilt angle by a fixed angle. The fixed angle may be 0.5-5 degrees, or 1 or 2 or 3 or 4 degrees. In an embodiment, the new antenna tilt angle is further uptilted until the main radiation beam reach is greater than or equal to the characteristic user equipment distance. In this way, the antenna is further uptilted until the predefined percentage of user equipment are reached by the main radiation beam, which may result in improving signal levels of the user equipment. In an embodiment, the new antenna tilt angle is further uptilted until a pre-set antenna tilt angle limit is reached. In an embodiment, the new antenna tilt angle is further uptilted until a maximum allowed reach of the main radiation beam reach is reached. Uptilting an antenna extends a main radiation beam reach of said antenna. Downtilting an antenna reduces a main radiation beam reach of said antenna. The main radiation beam reach and/or the antenna tilt angle may be limited to avoid interference with other cells. The main radiation beam reach and/or the antenna tilt angle may be limited such that uptilting an antenna is restricted by limiting interference with a cell in a neighbouring base station. In an embodiment, the maximum allowed reach extends at most to 7th or 8th or 9th or 10th decile of the user equipment distances. In an embodiment, the maximum allowed reach extends at most to a distance comprising 70-100% of the user equipment, or 70% or 80% or 90% or 100% of the user equipment. In an embodiment, the maximum allowed reach is at most 0.6-1.0 times the distance from the base station to a nearest neighbour. The nearest neighbour may comprise any one of: a nearest neighbouring base station, a nearest same frequency cell, a nearest neighbouring base station inside antennas horizontal main radiation beam width in the direction of said antenna, or a nearest same frequency cell inside antennas horizontal main radiation beam width in the direction of said antenna. Indoor cells may be excluded. In some embodiments, the main radiation beam width is 60 degrees. In a further embodiment, the maximum allowed reach is at most 0.7 or 0.8 or 0.9 times the distance from the base station to the nearest neighbour. In an embodiment, the new antenna tilt angle is iterated once or twice or thrice.

360: Optionally, deploying the new antenna tilt angle to the first antenna. By deploying the new antenna tilt angle to first antenna, the main radiation beam of the first antenna may optimize the traffic served by the main radiation beam thereby optimizing the traffic of the user equipment in the one or more cells that use the first antenna.

In an example embodiment of a flat terrain, the main radiation beam reach in step 320 is calculated as: reach=antenna_height*tan(90²−tilt_3 dB_angle), where antenna_height is the height of the first antenna from the ground level, and tilt_3 dB_angle, relative to the horizontal line, may be calculated as: tilt_3 dB_angle=antenna tilt angle−3 dB attenuation angle, where the 3 dB attenuation angle is the angle between the directions of the maximum power and the 3 dB attenuated power of the main radiation beam. In an embodiment, the tilt_3 dB_angle is the angle, relative to the horizontal line, of a line pointing from the first antenna to a 3 dB_point, and the 3 dB_point is a point where the 3 dB attenuated main radiation beam crosses the terrain height level of the base station of the first antenna. In some embodiments, a main radiation beam reach calculated for a flat terrain is used as an estimate for a main radiation beam reach in a grainy or non-flat terrain.

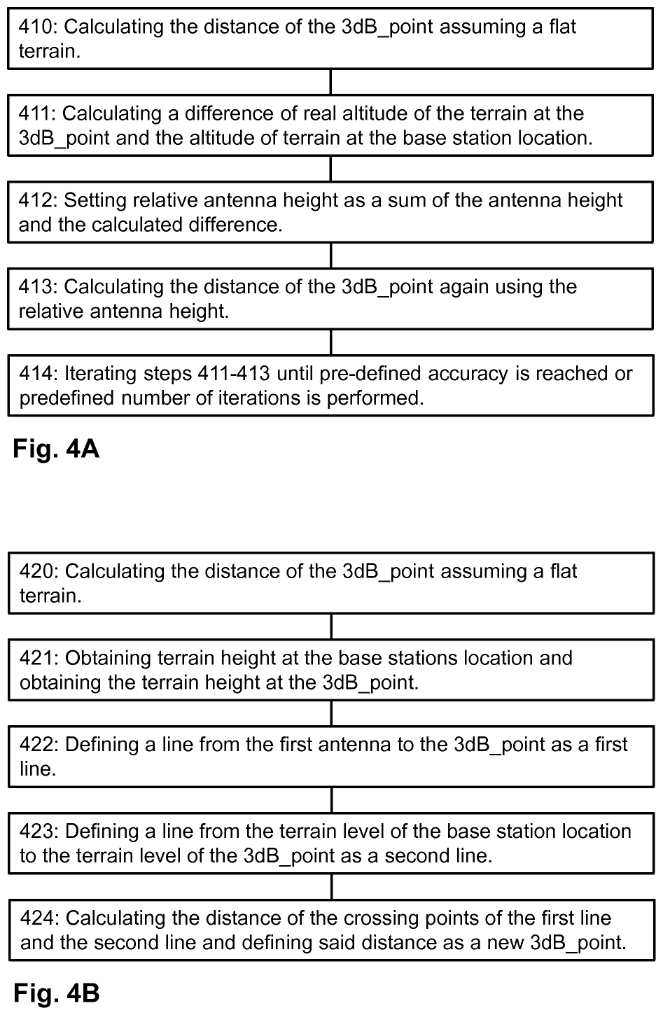

FIGS. 4A and 4B show example embodiments related to non-flat terrain. In an example embodiment of decreasing terrain height, shown in FIG. 4A, the main radiation beam reach in step 320 may be calculated as:
410: Calculating the distance of the 3 dB_point assuming a flat terrain. The distance is calculated using the formula: antenna_height*tan(90°−tilt_3 dB_angle).
411: Calculating a difference of real altitude of the terrain at the 3 dB_point and the altitude of terrain at the base station location. The terrain height may be obtained from topographical data, map data, geographical data, and/or terrain height data.
412: Setting relative antenna height as a sum of the antenna height and the calculated difference.
413: Calculating the distance of the 3 dB_point again using the relative antenna height. The distance is calculated using the formula: relative_antenna_height*tan(90°−tilt_3 dB_angle).
414: Iterating steps 411-413 until pre-defined accuracy is reached or pre-defined number of iterations is performed.

In an example embodiment of increasing terrain height, shown in FIG. 4B, the main radiation beam reach in step 320 may be calculated as:
420: Calculating the distance of the 3 dB_point assuming a flat terrain.
421: Obtaining terrain height at the base stations location and obtaining the terrain height at the 3 dB_point. The terrain height may be obtained from topographical data, map data, geographical data, and/or terrain height data.
422: Defining a line from the first antenna to the 3 dB_point as a first line.
423: Defining a line from the terrain level of the base station location to the terrain level of the 3 dB_point as a second line.
424: Calculating the horizontal distance of the crossing point of the first line and the second line from the base station and defining said distance as a new 3 dB_point. The distance is calculated using the formula:

antenna_height/((antenna_height/3 dB_point distance at flat terrain)+((terrain height at the distance of flat terrain 3 dB_point−terrain height at the base station location)/3 dB_point distance at flat terrain)).

The approaches of FIGS. 4A and 4B may be used in grainy terrains wherein the overall terrain profile is, respectively, decreasing or increasing.

Without in any way limiting the scope, interpretation, or application of the appended claims, a technical effect of one or more of the example embodiments disclosed herein is that one may achieve improved signal quality and improved signal to noise ratio of a cell. An advantage is also that the improved signal quality may increase the capacity of the cell as the main radiation beam reach of the antenna is set to cover predefined percentage of the user equipment. A further advantage is that, due to increased capacity, setting up new unnecessary cells may be avoided.

A further technical effect of one or more of the example embodiments disclosed herein is that instead of focusing on downtilting antennas to avoid interference, a mechanism is provided for controllably uptilting antennas, where possible.

Any of the afore described methods, method steps, or combinations thereof, may be controlled or performed using hardware; software; firmware; or any combination thereof. The software and/or hardware may be local; distributed; centralised; virtualised; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logics; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the solutions of the present disclosure. It is however clear to a person skilled in the art that the solutions of the present disclosure are not restricted to details of the embodiments presented in the foregoing, but that it can be implemented in other embodiments using equivalent means or in different combinations of embodiments without deviating from the characteristics of the solutions of the present disclosure.

Furthermore, some of the features of the afore-disclosed example embodiments may be used to advantage without the corresponding use of other features. As such, the foregoing description shall be considered as merely illustrative of the principles of the present disclosure, and not in limitation thereof. Hence, the scope of the present disclosure is only restricted by the appended patent claims.

1. A computer implemented method for adjusting a tilt angle of an antenna of a base station of a communications network, the method comprising:
obtaining data related to the base station, the data comprising user equipment distance data and antenna data;
calculating a main radiation beam reach for a first antenna from the antenna data;
calculating a characteristic user equipment distance from the user equipment distance data;
comparing the calculated main radiation beam reach and the calculated characteristic user equipment distance; and
responsive to detecting that the characteristic user equipment distance is greater than the main radiation beam reach, calculating a new antenna tilt angle for the first antenna to uptilt the first antenna.

2. The method of claim 1, wherein characteristic user equipment distance is a distance comprising a predefined percentage of user equipment in one or more cells that use the first antenna.

3. The method of claim 1, wherein the antenna data comprises antenna radiation pattern data, antenna height data, and antenna tilt angle data.

4. The method of claim 1, wherein the main radiation beam reach of the first antenna is calculated as a distance from the base station, where the radiation power of the main radiation beam of the first antenna decreases to a pre-set portion of the maximum radiation power of the main radiation beam.

5. The method of claim 4, wherein the pre-set portion of the maximum radiation power of the main radiation beam is a half of the maximum radiation power or a 3 dB attenuated power of the maximum power.

6. The method of claim 2, wherein the pre-defined percentage is 40% or 50% or 60% or 70% of the user equipment.

7. The method of claim 1, wherein the user equipment distance data comprises timing advance TA data.

8. The method of claim 1, wherein the main radiation beam reach is limited by a maximum allowed reach.

9. The method of claim 8, wherein the maximum allowed reach extends at most to 7th or 8th or 9th or 10th decile of the user equipment distances.

10. The method of claim 8, wherein the maximum allowed reach extends at most to a distance comprising 70-100% of the user equipment, or 70% or 80% or 90% or 100% of the user equipment.

11. The method of claim 8, wherein the maximum allowed reach is at most 0.6-1.0 times the distance from the base station to a nearest neighbour, or the maximum allowed reach is at most 0.8 times the distance from the base station to the nearest neighbour.

12. The method of claim 8, wherein the new antenna tilt angle is further uptilted until the main radiation beam reach is greater than the characteristic user equipment distance and/or the maximum allowed reach is reached and/or a pre-set antenna tilt angle limit is reached.

13. The method of claim 1, wherein altitude of the ground is accounted for in calculating the main radiation beam reach.

14. The method of claim 1, wherein the calculated new antenna tilt angle is deployed to the first antenna.

15. An apparatus comprising:
a processor; and
a memory including computer program code; the memory and the computer program code configured to, with the processor, cause the apparatus
to obtain data related to the base station, the data comprising user equipment distance data and antenna data;
to calculate a main radiation beam reach for a first antenna from the antenna data;
to calculate a characteristic user equipment distance from the user equipment distance data;
to compare the calculated main radiation beam reach and the calculated characteristic user equipment distance; and
responsive to detecting that the characteristic user equipment distance is greater than the main radiation beam reach, to calculate a new antenna tilt angle for the first antenna to uptilt the first antenna.

16. A computer program comprising computer executable program code which when executed by a processor causes an apparatus to perform
obtaining data related to the base station, the data comprising user equipment distance data and antenna data;
calculating a main radiation beam reach for a first antenna from the antenna data;
calculating a characteristic user equipment distance from the user equipment distance data;
comparing the calculated main radiation beam reach and the calculated characteristic user equipment distance; and
responsive to detecting that the characteristic user equipment distance is greater than the main radiation beam reach, calculating a new antenna tilt angle for the first antenna to uptilt the first antenna.
